(19) United States
(12) Patent Application Publication
(10) Pub. No.: US 2021/0263969 A1
(43) Pub. Date: Aug. 26, 2021

(54) INFORMATION PROCESSING APPARATUS, INFORMATION EXCHANGE SYSTEM, INFORMATION PROCESSING METHOD, AND INFORMATION PROCESSING PROGRAM

(71) Applicant: NIPPON TELEGRAPH AND TELEPHONE CORPORATION, Tokyo (JP)

(72) Inventors: Jingyu SUN, Musashino-shi, Tokyo (JP); Masato KAMIYA, Musashino-shi, Tokyo (JP); Susumu TAKEUCHI, Musashino-shi, Tokyo (JP)

(73) Assignee: NIPPON TELEGRAPH AND TELEPHONE CORPORATION, Tokyo (JP)

(21) Appl. No.: 17/252,394

(22) PCT Filed: Jun. 7, 2019
(86) PCT No.: PCT/JP2019/022723

§ 371 Date: Dec. 15, 2020

(30) Foreign Application Priority Data
Jun. 20, 2018 (JP) 2018-116727

(51) Int. Cl. G06F 16/906; G06F 16/907; G06F 16/901; G06K 9/62

(52) U.S. Cl. CPC G06F 16/906; G06K 9/6276; G06F 16/9027; G06F 16/907

(57) ABSTRACT

An information processing apparatus in embodiments includes a feature extraction unit configured to extract a plurality of features from a data group supplied from a device and generate a group of feature vectors obtained by representing the plurality of features with vectors, a hierarchical shaping unit configured to perform clustering according to a distance between feature vectors on the group of feature vectors generated by the feature extraction unit to generate a cluster tree obtained by hierarchizing cluster groups generated by the clustering according to a distance between the clusters, a metadata annotation unit configured to generate a metadata tree, the metadata tree including, for each of the clusters, metadata obtained by annotating a synopsis obtained by summarizing information under each of the clusters, based on the cluster tree generated by the hierarchical shaping unit, and a metadata search unit configured to search the metadata tree generated by the metadata annotation unit for metadata of a cluster suitable for a usage indicated by an application and provide the metadata obtained through the search to the application.

### TECHNICAL FIELD

Embodiments of the present invention relate to an information processing apparatus, an information exchange system, an information processing method, and an information processing program.

### BACKGROUND ART

In recent years, a technology for collecting a large amount of raw data generated from devices such as various sensors into a server on a cloud and utilizing the data for a client-side application indicating various usages in a network environment of the Internet of Things (IoT) has been developed.

In general, the server on the cloud collects various types of IoT data transmitted in a large amount and continuously into a database in a time-series as it is, and the application acquires required data among from the IoT data and utilizes the required data.

While the amount of data accumulated in the database on the server side is large, usages for the data required by the application may often be in real time and diverse. Further, analysis of meanings (semantics) of the data is generally performed on the application side.

### CITATION LIST

### Non Patent Literature

Non Patent Literature 1: Payam Barnaghi, Friender Ganz, Cory Henson, and Amit Sheth, “Computing Perception from Sensor Data,” KNO. E. SIS PUBLICATIONS, October 2012
Non Patent Literature 2: Atif Alamri, Wasai Shadab Ansari, Mohammad Mehedi Hassan, M. Shamim Hossain, Abdulhameed Alelaiwi, and M. Anwar Hossain, “A Survey on Sensor-Cloud: Architecture, Applications, and Approaches,” Hindawi Publishing Corporation, International Journal of Distributed Sensor Networks, Volume 2013
Non Patent Literature 3: Wu He, Gongjun Yan, and Li Da Xu, “Developing Vehicular Data Cloud Services in the IoT Environment,” IEEE Transactions on Industrial Informatics, Vol. 10, No. 2, pp. 1587-1595, May 2014

### SUMMARY OF THE INVENTION

### Technical Problem

Various applications need to acquire large amounts of raw data from the server in order to utilize raw data generated from devices such as various sensors, which causes large communication costs and network resource costs. For example, when the various applications access the server and search for the required data according to respective usages and extract large amounts of data, communication costs of a network and the like are enormous. Further, because the application performs the analysis after processing the received raw data so that the processed data fits the usage, a load on the application side increases.

On the other hand, even when the server processes and analyzes the raw data so that the processed and analyzed data fits the usages indicated by the applications and then passes the data to the applications, it is practically difficult for the server to perform such a process in advance because the usages indicated by the individual applications are different from each other.

An object of the present invention is to provide an information processing apparatus, an information exchange system, an information processing method, and an information processing program that enable data required by applications to be efficiently generated.

### Means for Solving the Problem

To achieve the above object, a first aspect of an information processing apparatus in an embodiment of the present invention includes: a feature extraction unit configured to extract a plurality of features from a data group supplied from a device and generate a group of feature vectors obtained by representing the plurality of features with vectors; a hierarchical shaping unit configured to perform clustering according to a distance between feature vectors on the group of feature vectors generated by the feature extraction unit to generate a cluster tree obtained by hierarchizing cluster groups generated by the clustering according to a distance between the clusters; a metadata annotation unit configured to generate a metadata tree, the metadata tree including, for each of the clusters, metadata obtained by annotating a synopsis obtained by summarizing information under each of the clusters, based on the cluster tree generated by the hierarchical shaping unit; and a metadata search unit configured to search the metadata tree generated by the metadata annotation unit for metadata of a cluster suitable for a usage indicated by an application and provide the metadata obtained through the search to the application.

According to a second aspect of the present invention, in the information processing apparatus of the first aspect, when the application indicates a granularity of a data group as the usage, the metadata search unit reads a metadata of a cluster located in a layer corresponding to the granularity from the metadata tree.

According to a third aspect of the present invention, in the information processing apparatus of the first aspect, when an application designates a range of physical amounts of the data group as a usage, the metadata search unit traverses the metadata tree from a top layer toward a bottom layer, and sequentially narrows down the range of the physical amounts recorded in the metadata of each of the clusters, to thereby find and read metadata in which the corresponding range is recorded.

According to a fourth aspect of the present invention, the information processing apparatus in any one of the first to third aspects further includes: a shaping condition setting unit configured to adjust parameters used in a process by the feature extraction unit, the hierarchical shaping unit, or the metadata annotation unit according to the usage indicated by the application.

One aspect of an information processing system in an embodiment of the present invention is an information exchange system for exchanging information between one or a plurality of first information processing apparatuses storing a data group supplied from a device and a second information processing apparatus responding to a request from an application, wherein each of the one or plurality of first information processing apparatuses includes a feature extraction unit configured to extract a plurality of features from the data group supplied from the device and generate a group of feature vectors obtained by representing the plurality of features with vectors; a hierarchical shaping unit configured to perform clustering according to a distance between feature vectors on the group of feature vectors generated by the feature extraction unit to generate a cluster tree obtained by hierarchizing cluster groups generated by the clustering according to a distance between the clusters; and a metadata annotation unit configured to generate a metadata tree, the metadata tree including, for each of the clusters, metadata obtained by annotating a synopsis obtained by summarizing information under each of the clusters, based on the cluster tree generated by the hierarchical shaping unit, and the second information processing apparatus includes a metadata search unit configured to request any one of the one or plurality of first information processing apparatuses to search the metadata tree generated by the metadata annotation unit for metadata of a cluster suitable for a usage indicated by the application, and provide the metadata obtained through the search to the application.

One aspect of an information processing method in an embodiment of the present invention includes extracting a plurality of features from a data group supplied from a device and generating a group of feature vectors obtained by representing the plurality of features with vectors; classifying the generated group of feature vectors into a plurality of clusters according to a distance between feature vectors and generating a cluster tree obtained by hierarchizing the plurality of clusters according to a distance between the clusters; generating a metadata tree, the metadata tree including, for each of the clusters, metadata obtained by annotating a synopsis obtained by summarizing information under each of the clusters, based on the generated cluster tree; and searching the generated metadata tree for metadata of a cluster suitable for a usage indicated by an application and providing the metadata obtained through the search to the application.

One aspect of an information processing program according to an embodiment of the present invention is an information processing program used in a computer operating as a part of the information processing apparatus in the first aspect, the information processing program causing the computer to function as the feature extraction unit, the hierarchical shaping unit, the metadata annotation unit, and the metadata search unit.

### Effects of the Invention

According to the first aspect of the information processing apparatus in the embodiment of the present invention, it is possible to efficiently generate data required by the application.

According to the second aspect of the information processing apparatus in the embodiment of the present invention, because information on each of the clusters on a layer corresponding to a granularity can be easily identified, it is possible to easily obtain desired information in a short time without needing to continue to search for information on each of the clusters in other layers after it is identified.

According to the third aspect of the information processing apparatus in the embodiment of the present invention, because it is possible to easily find a designation range by traversing in order from the top layer based on the metadata tree that forms a hierarchical structure, it is possible to easily obtain desired information in a short time without needing to continue to search for information on respective clusters on lower layers after the designation range is found.

According to the fourth aspect of the information processing apparatus in the embodiment of the present invention, because, when metadata corresponding to the setting of the parameters indicated by the usage of the application is not present in the metadata storage unit, the shaping condition setting unit adjusts the parameters used in the process by the feature extraction unit, the hierarchical shaping unit, or the metadata annotation unit, it is possible to appropriately handle the usage indicated by the application.

According to an aspect of the information processing system in the embodiment of the present invention, because the feature extraction unit, the hierarchical shaping unit, and the metadata annotation unit are disposed on the first information processing apparatus side rather than being disposed on the second information processing apparatus side, the second information processing apparatus does not need to receive and process a large amount of raw data and merely performs transfer of the metadata. Thus, it is possible to greatly reduce a load on the second information processing apparatus.

### BRIEF DESCRIPTION OF DRAWINGS

FIG. 1 is a diagram illustrating an example of a configuration of an information processing apparatus according to a first embodiment of the present invention.

FIG. 2 is a diagram illustrating an example of a data structure of a raw data group stored in a raw data storage unit in a server, a data structure of a cluster tree stored in a cluster storage unit, and a data structure of a metadata tree stored in a metadata storage unit.

FIG. 3A is a diagram illustrating an example of a metadata search that a metadata search unit performs on a metadata tree.

FIG. 3B is a diagram illustrating an example of a metadata search that a metadata search unit performs on a metadata tree.

FIG. 4 is a diagram illustrating various elements relevant to an operation at the time of data shaping and annotation.

FIG. 5 is a diagram illustrating an example of a flow of information exchanged between various elements relevant to the operation at the time of data shaping and annotation.

FIG. 6 is a flowchart showing an example of an operation at the time of data shaping and annotation in the feature extraction unit, the hierarchical shaping unit, and the metadata annotation unit.

FIG. 7 is a diagram illustrating various elements relevant to an operation of a metadata search or the like.

FIG. 8 is a diagram illustrating an example of a flow of information exchanged between various elements relevant to the operation at the time of a metadata search (here, when a metadata tree that is a search target is present in the metadata storage unit).

FIG. 9 is a diagram illustrating an example of a flow of information exchanged between various elements relevant to the operation at the time of a metadata search (here, when a metadata tree that is a search target is not present in the metadata storage unit).

FIG. 10 is a flowchart showing an example of an operation at the time of a metadata search in a metadata search unit and the like.

FIG. 11 is a flowchart showing a specific process of step S46 in FIG. 10.

FIG. 12A is a diagram illustrating an example of information stored in a metadata storage unit.

FIG. 12B is a diagram illustrating an example of information stored in a metadata storage unit.

FIG. 13A is a diagram illustrating an example of a cluster tree in Example (1).

FIG. 13B is a diagram illustrating an example of metadata in Example (1).

FIG. 14A is a diagram illustrating an example of histograms of various features in Example (1).

FIG. 14B is a graph showing an example of graphs representing a cluster group in Example (1).

FIG. 15 is a diagram illustrating an example of an ontology representing metadata in Example (1).

FIG. 16A is a diagram illustrating another example of the cluster tree in Example (1).

FIG. 16B is a diagram illustrating another example of the metadata in Example (1).

FIG. 17A is a diagram illustrating another example of the histograms of various features in Example (1).

FIG. 17B is a graph showing another example of the graphs representing a cluster group in Example (1).

FIG. 18A is a diagram illustrating an example of a cluster tree in Example (2).

FIG. 18B is a diagram illustrating an example of metadata in Example (2).

FIG. 19A is a diagram illustrating an example of a correlation between various features in Example (2).

FIG. 19B is a diagram illustrating an example of a graph representing a cluster group in Example (2).

FIG. 20 is a diagram illustrating an example of an ontology representing metadata in Example (2).

FIG. 21 is a diagram illustrating an example of a cluster tree in Example (2).

FIG. 22A is a diagram illustrating another example of the correlation between various features in Example (2).

FIG. 22B is a graph showing another example of the graph representing the cluster group in Example (2).

FIG. 23 is a diagram illustrating an example of a functional configuration of an information exchange system according to a second embodiment of the present invention.

### DESCRIPTION OF EMBODIMENTS

Hereinafter, embodiments of the present disclosure will be described.

### First Embodiment

Hereinafter, a first embodiment according to the present invention will be described.

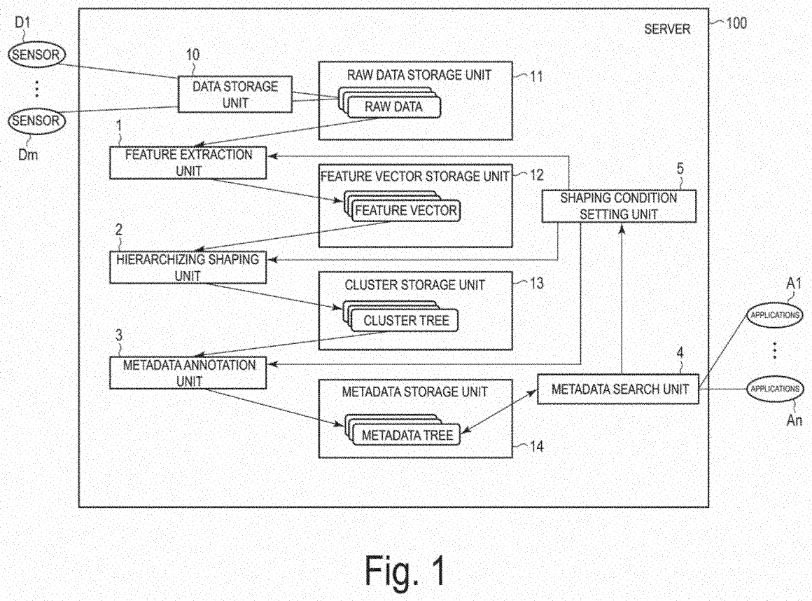

Configuration FIG. 1 is a diagram illustrating an example of a configuration of an information processing apparatus according to the first embodiment of the present invention.

The information processing apparatus according to the embodiment is realized as, for example, a server 100 on a cloud that provides services in response to requests from applications installed in other information processing apparatuses (not shown).

The server 100 can store, for example, a sensing data group supplied from a group of devices such as a plurality of external sensors D1 to Dm and the like (for example, a wind speed sensor, an air temperature sensor, a sunlight time sensor) in a database, and transmits data requested from any application in a group of applications A1 to An on the external client side to an application that is a request source.

The group of applications A1 to An include, for example, (i) an application that performs granularity-specific data analysis, (ii) an application that performs composite condition analysis, and (iii) an application that performs condition-designated data search or the like. The granularity-specific data analysis is, for example, data analysis in which the number of classifications of wind speed data indicating a wind speed situation is changed into 3, 12. The composite condition analysis is, for example, analysis of an influence on crops according to a weather situation in which wind speed, air temperature, and sunlight time are combined. The condition-designated data search is, for example, a data search in which “air temperature >34 degrees” is designated.

The server 100 includes, as various functions, a feature extraction unit 1, a hierarchical shaping unit 2, a metadata annotation unit 3, a metadata search unit 4, a shaping condition setting unit 5, a data storage unit 10, a raw data storage unit 11, a feature vector storage unit 12, a cluster storage unit 13, and a metadata storage unit 14. These functions are realized using a processor such as a central processing unit (CPU) that executes a program, and a storage medium such as a random access memory (RAM) or a read only memory (ROM).

The functional configuration is not limited to that shown in FIG. 1 and may be appropriately modified in other embodiments. Further, the various functions shown in FIG. 1 are not all essential elements, and some of the functions can be omitted. For example, the shaping condition setting unit 5 may not be mounted in an environment that does not require a setting of shaping conditions to be described below.

The data storage unit 10 has a function of temporarily buffering a sensing data group of various types supplied from the sensors D1 to Dm and the like (for example, a data group indicating physical amounts such as wind speed, air temperature, sunlight time, and the like at a certain place), and then sending the group of sensing data to the raw data storage unit 11.

The raw data storage unit 11 has a function of sequentially receiving sensing data group (raw data group) transmitted from the data storage unit 10, recording the sensing data group in a recording medium, and outputting the sensing data group to the feature extraction unit 1.

The feature extraction unit 1 has a function of extracting a plurality of features from the sensing data group (that is, a raw data group obtained from the raw data storage unit 11) supplied from the sensors D1 to Dm and the like and generating a group of feature vectors obtained by representing the plurality of features with vectors. Here, the plurality of features are, for example, information such as a maximum value or an average value of the wind speed per unit time, a maximum value or an average value of the air temperature per unit time, a daily sunlight time, and the like. Further, the group of feature vectors is, for example, a group of feature vectors including information on the maximum value and the average value of the wind speed per hour, a group of feature vectors including information on composite weather of the current day (the wind speed, the air temperature, and the sunlight time), and a group of feature vectors including information on the average air temperature of the current day.

The feature vector storage unit 12 has a function of receiving the group of feature vectors generated by the feature extraction unit 1, recording the group of feature vectors in a recording medium, and outputting the group of feature vectors to the hierarchical shaping unit 2.

The hierarchical shaping unit 2 has a function of performing clustering according to the distance between feature vectors on the group of feature vectors generated by the feature extraction unit 1 (that is, group of feature vectors obtained from the feature vector storage unit 12) and generating a cluster tree in which a cluster group generated by the clustering is hierarchized according to a distance between clusters.

The cluster storage unit 13 has a function of receiving the cluster tree generated by the hierarchical shaping unit 2, recording the cluster tree in a recording medium, and outputting the cluster tree to the metadata annotation unit 3.

The metadata annotation unit 3 has a function of generating a metadata tree based on the cluster tree generated by the hierarchical shaping unit 2 (that is, the cluster tree obtained from the cluster storage unit 13). The metadata tree is a tree in which metadata obtained by annotating a synopsis obtained by summarizing information under each of the clusters of the cluster tree is included in each of the clusters. The annotation is, for example, information such as createdBefore (comparison between data generation times), better, and higher (comparison between values of data).

Information for identifying the cluster (such as a number of the cluster), a feature such as a maximum value and an average value, a generation time, a data count, a storage place, and relative semantics, for example, are included in the synopsis of each of the clusters. However, the information included in the synopsis is different for each layer. The relative semantics are information indicating a relative relationship to other clusters on the same layer, and are obtained by inference using a predetermined algorithm using various types of information. These relative semantics correspond to the annotation described above.

The metadata storage unit 14 has a function of receiving the metadata tree generated by the metadata annotation unit 3, recording the metadata tree in a recording medium, and outputting the metadata of the cluster in the metadata tree to the metadata search unit 4 in response to a request from the metadata search unit 4.

The metadata search unit 4 has a function of searching the metadata tree generated by the metadata annotation unit 3 (that is, the metadata tree stored in the metadata storage unit 14) for the metadata of the cluster suitable for the usage indicated by the application, and providing the metadata obtained through the search to the application that is a request source.

For example, when the application designates the granularity of the data group, the metadata search unit 4 reads the metadata of the cluster located in the layer corresponding to the granularity from the metadata tree. The granularity may be designated in the form of a cluster count, the layer of the cluster, or the distance between the clusters.

When the application designates a range of physical amounts of the data group, the metadata search unit 4 traverses the metadata tree from the top layer toward the bottom layer and sequentially narrows down the range of the physical amounts recorded in the metadata of each of the clusters, thereby finding and reading metadata in which the corresponding range is recorded.

The shaping condition setting unit 5 has a function of changing the setting of the shaping condition of the data group by adjusting the group of parameters used in a process by the feature extraction unit 1, the hierarchical shaping unit 2, or the metadata annotation unit 3 according to a usage indicated by the metadata search unit 4 (that is, the usage indicated by the application that is a request source).

For example, when it is necessary for the shaping condition of the data in the feature extraction unit 1 to be adjusted, the shaping condition setting unit 5 instructs the feature extraction unit 1 to set feature extraction parameters (parameters for designating a time interval (segment) of data that is a target, a span (TimeSpan), an algorithm used for feature extraction, and the like).

Further, when it is necessary for the shaping condition of the data in the hierarchical shaping unit 2 to be adjusted, the shaping condition setting unit 5 instructs the hierarchical shaping unit 2 to set hierarchical shaping parameters (parameters for designating a cluster count, a cluster tree layer count, a distance between the clusters, an algorithm used for hierarchical shaping, and the like).

Further, when it is necessary for the shaping condition of the data in the metadata annotation unit 3 to be adjusted, the shaping condition setting unit 5 instructs the metadata annotation unit 3 to set metadata annotation parameters (parameters for designating an annotation category (an item that is a target of metadata annotation), an algorithm used for metadata annotation, and the like).

The raw data storage unit 11, the feature vector storage unit 12, and the cluster storage unit 13 may each be configured to have a function of performing an event notification. In this case, when new information arrives (when the new information is input and stored), the raw data storage unit 11, the feature vector storage unit 12, and the cluster storage unit 13 transmit an event indicating that fact to the feature extraction unit 1, the hierarchical shaping unit 2, and the metadata annotation unit 3, respectively. The feature extraction unit 1, the hierarchical shaping unit 2, and the metadata annotation unit 3 each receive an event notification, and then acquire information from the raw data storage unit 11, the feature vector storage unit 12, and the cluster storage unit 13.

On the other hand, in the case of a configuration in which the raw data storage unit 11, the feature vector storage unit 12, and the cluster storage unit 13 do not have an event notification function (for example, a configuration such as a simple relational database (RDB)), the raw data storage unit 11, the feature vector storage unit 12, and the cluster storage unit 13 each periodically acquire information from the raw data storage unit 11, the feature vector storage unit 12, and the cluster storage unit 13.

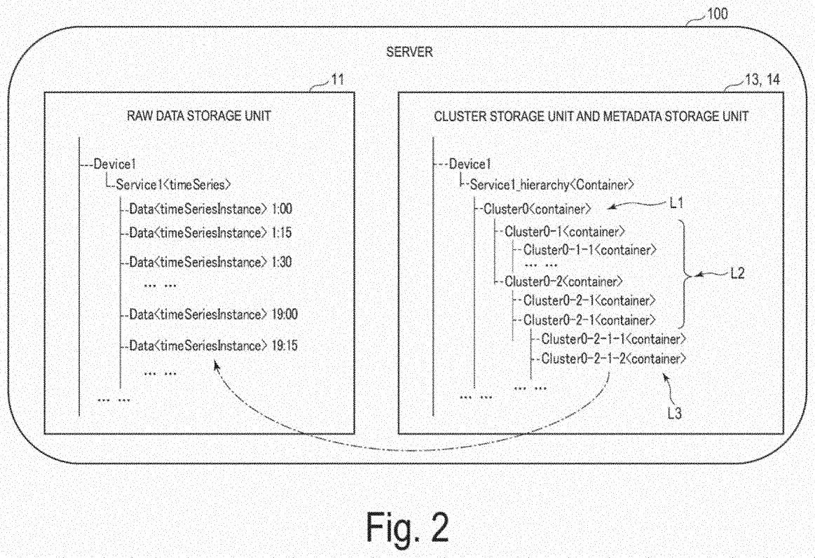

Data Structure FIG. 2 is a diagram illustrating an example of a data structure of the raw data group stored in the raw data storage unit 11 in the server 100, a data structure of the cluster tree stored in the cluster storage unit 13, and a data structure of the metadata tree stored in the metadata storage unit 14.

In the raw data storage unit 11, the raw data group is recorded in a time series in a predetermined data table.

For example, “Device1, . . . ” is disposed as an item for identifying respective devices such as the sensors D1 to Dm and the like, and “Service1<timeSeries>, . . . ” is disposed as an item indicating, for example, a type of service or data regarding the device under each of “Device1, . . . ”. Individual raw data “Data<timeSeriesInstance>” obtained at each point in time is recorded together with time information indicating an acquisition time under each of “Service1<timeSeries>, . . . ”. The raw data with the time information is recorded in the same layer.

On the other hand, in the cluster storage unit 13 or the metadata storage unit 14, information on the cluster group hierarchized by shaping is stored in each <container> resource. In the metadata storage unit 14, various types of information to be described below are recorded in the form of metadata.

For example, an item “Device1, . . . ” like that described above is disposed in the cluster storage unit 13 or the metadata storage unit 14. Further, “Service1_hierarchy<Container>, . . . ” is disposed as an item indicating, for example, a type of service or data regarding the device under each of “Device1, . . . ”. Further, an item for identifying each of the cluster groups is disposed in the form of a hierarchical structure including, for example, a top layer L1, an intermediate layer L2, and a bottom layer L3 under “Service1_hierarchy<Container>, . . . ”. Each item is provided with container <container> for storing various type of information regarding the cluster.

A “Cluster0<container>, . . . ”, for example, is disposed on the top layer L1. “Cluster0-1 <container>, Cluster0-1<container>, . . . ” or “Cluster0-1-1<container>, . . . ” or “Cluster0-2-1 <container>, . . . ” under these, and the like, for example, are disposed in the intermediate layer L2. “Cluster0-2-1-1<container>, Cluster0-2-1-2<container>, . . . ”, and the like, for example, are disposed in the bottom layer L3.

Statistical values (a maximum value, a minimum value, an average value, and the like) of all data groups are recorded in the container <container> of the cluster of the top layer L1. In the container <container> of the cluster of the intermediate layer L2, statistical values (a maximum value, a minimum value, an average value, and the like) of all data groups under the cluster are recorded and relative semantics obtained by inferring using a predetermined algorithm are recorded. Further, information on a link to corresponding raw data (for example, “Data <timeSeriesInstance>19:15” stored in the raw data storage unit 11), for example, is recorded in the container <container> of the cluster of the bottom layer.

Search Method

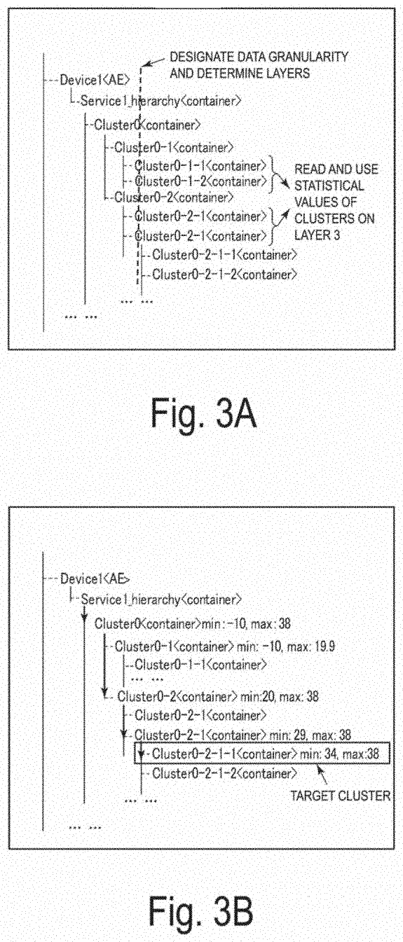

FIGS. 3A and 3B illustrate an example of a metadata search that the metadata search unit 4 performs on the metadata tree.

FIG. 3A shows an example of a search when the application indicates granularity of data or granularity of a time in usage.

When an application indicates, for example, “time granularity” in order to perform “statistical graph creation,” the metadata search unit 4 determines data granularity corresponding to the time granularity, and then determines a layer corresponding to the data granularity. Further, when the application indicates, for example, “granularity of data” in order to perform “granularity-specific data management,” the metadata search unit 4 determines a layer corresponding to the “granularity of data.” When the corresponding layer is, for example, a third layer, the metadata search unit 4 reads information such as statistical values stored in container <container> of each of the clusters in the third layer.

In the example of FIG. 3A, it is possible to easily identify information on each of the clusters in the corresponding layer from the granularity based on the metadata tree forming the hierarchical structure. Therefore, after the metadata search unit 4 identifies the information on each of the clusters, the metadata search unit 4 can easily obtain desired information in a short time without needing to continue to search for information on each of the clusters in other layers.

FIG. 3B shows an example of a search when an application indicates a temperature range in usage.

When the application designates, for example, a “range of air temperature” in order to perform a “conditional search,” the metadata search unit 4 traverses the metadata tree from the top layer toward the bottom layer, and sequentially narrows down a range of physical amounts recorded in the container <container> of each of the clusters. When the designated range of the air temperatures is “min:34 (air temperature >34 degree),” the metadata search unit 4 traverses from the top layer toward the bottom layer until “min:34” is found. When “min:34” is found, the metadata search unit 4 reads the information on the container <container>.

In the example of FIG. 3B, it is possible to easily find the designation range by traversing in order from the top layer based on the metadata tree forming the hierarchical structure. Therefore, after the metadata search unit 4 finds the designation range, the metadata search unit 4 can easily obtain desired information in a short time without needing to continue to search for information on respective clusters in lower layers.

Operation

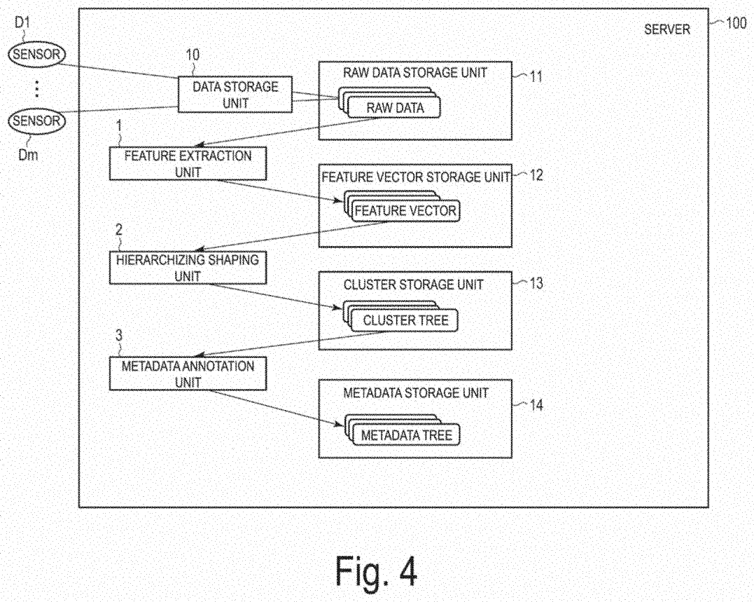

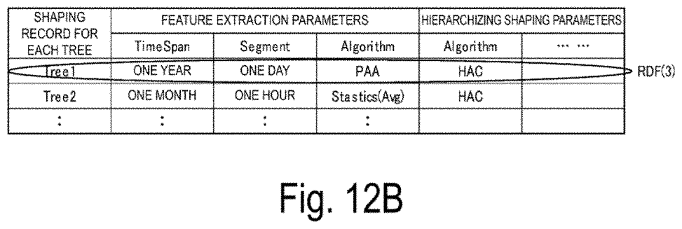

Hereinafter, an operation of the server 100 will be described with reference to FIGS. 4 to 11. Further, an example of information stored in the metadata storage unit 14 will be described together with appropriate reference to FIGS. 12A and 12B in description of the operation.

Operation at Time of Data Shaping and Annotation

First, an example of operations at the time of data shaping and annotation will be described with reference to FIGS. 4 to 6.

FIG. 4 shows various elements relevant to the operation at the time of data shaping and annotation.

As shown in FIG. 4, the various elements relevant to the operation at the time of data shaping and annotation are the sensors D1 to Dm, the raw data storage unit 11, the feature extraction unit 1, the feature vector storage unit 12, the hierarchical shaping unit 2, the cluster storage unit 13, the metadata annotation unit 3, and the metadata storage unit 14.

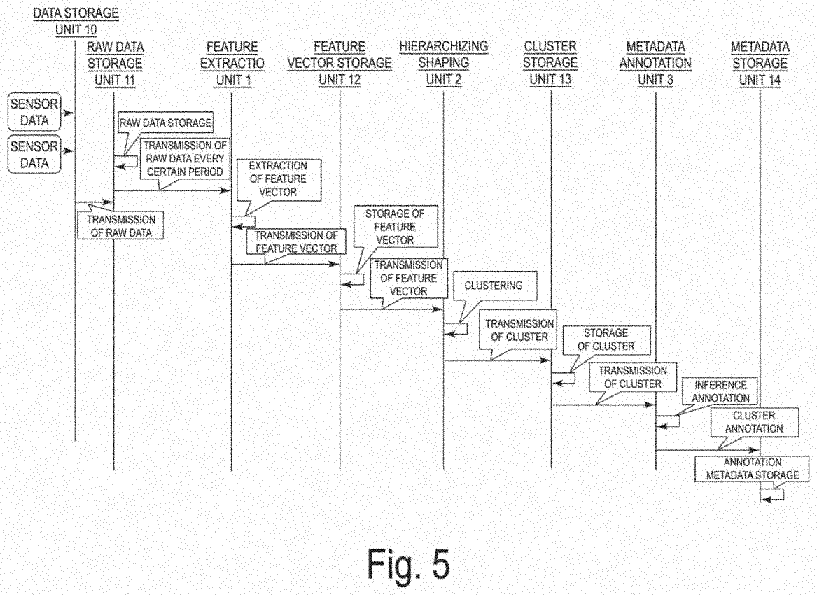

FIG. 5 is a diagram illustrating an example of a flow of information exchanged between various elements relevant to the operation at the time of data shaping and annotation.

As shown in FIG. 5, the sensing data group (raw data group) is transmitted from the sensors D1 to Dm and the like to the raw data storage unit 11.

The raw data storage unit 11 stores the received raw data group and transmits the raw data group to the feature extraction unit 1 every certain time.

The feature extraction unit 1 extracts the group of feature vectors from the received raw data group and transmits the group of feature vectors to the feature vector storage unit 12. The feature vector storage unit 12 stores the received group of feature vectors and transmits the group of feature vectors to the hierarchical shaping unit 2. The hierarchical shaping unit 2 performs clustering or the like on the received group of feature vectors and transmits the generated cluster group (cluster tree) to the cluster storage unit 13. The cluster storage unit 13 stores the received cluster group and transmits the cluster group to the metadata annotation unit 3. The metadata annotation unit 3 generates an annotation based on inference for each of the clusters based on the received cluster group, and transmits the metadata (the metadata tree) of the cluster group including the annotation to the metadata storage unit 14. The metadata storage unit 14 stores the received metadata.

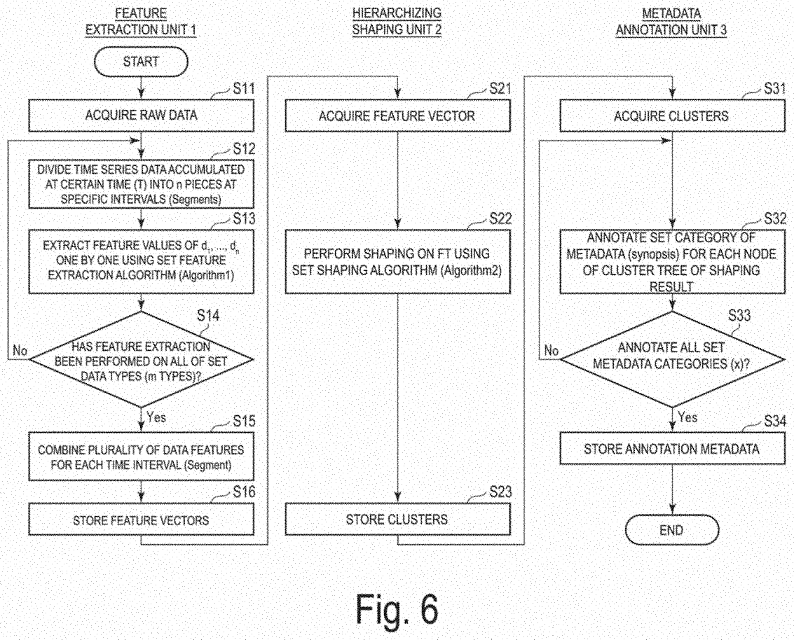

FIG. 6 is a flowchart showing an example of an operation at the time of data shaping and annotation in the feature extraction unit 1, the hierarchical shaping unit 2, and the metadata annotation unit 3.

The feature extraction unit 1 obtains the raw data group, as shown in FIG. 6 (S11).

Here, the feature extraction unit 1 divides data group (time series data) accumulated in the raw data storage unit 11 for a certain time (T) into n pieces at specific time intervals (segment) (S12).

The feature extraction unit 1 then extracts feature values of d₁, . . . , dₙ one by one using a pre-set feature extraction algorithm (Algorithm1) (S13).

Piecewise Aggregate Approximation (PAA), Statics, or Symbolic Aggregate Approximation (SAX), for example, may be adopted as the feature extraction algorithm (Algorithm1). When a feature extraction target is an image (for example, an image received from an image sensor or the like), an algorithm using Speed Up Robust Features (SURF), a Scaled Invariant Feature Transform (SIFT), or the like may be adopted.

The feature extraction unit 1 then determines whether the feature extraction has been performed on all of m preset types of data (for example, corresponding to various features such as temperature, humidity, and sunlight time) (S14). In accordance with a determination that the feature extraction has not been performed on all of the m preset data types (NO in S14), the feature extraction unit 1 repeats the process from step S12. On the other hand, in accordance with a determination that the feature extraction has been performed on all of the m preset data types (Yes in S14), the feature extraction unit 1 combines features of the plurality of data corresponding to the time intervals (segments) to generate a group of feature vectors (S15). In this case, the feature extraction unit 1 may weight a synopsis of a measurement time, a storage place, and the like of the data group and the extracted features to generate a group of feature vectors. The feature extraction unit 1 stores the generated group of feature vectors in the feature vector storage unit 12 (S16).

The hierarchical shaping unit 2 obtains the group of feature vectors from the feature vector storage unit 12 (S21).

Here, the hierarchical shaping unit 2 performs shaping on the group of feature vectors (FT) using a preset shaping algorithm (Algorithm2) (S22) to generate a cluster group (a cluster tree) and stores the cluster group in the cluster storage unit 13 (S23).

A Nearest Neighbor Chain, for example, may be adopted as the shaping algorithm (Algorithm2). In this case, a Ward method may be adopted as a distance function defining a distance between clusters.

The metadata annotation unit 3 acquires the cluster group (cluster tree) from the cluster storage unit 13 (S31).

Here, the metadata annotation unit 3 annotates the metadata “synopsis” of the preset category (for example, items such as a maximum value, a minimum value, an average value, and the like) for each of nodes (each cluster of each layer) of the cluster tree that is a shaping result (S32).

The metadata annotation unit 3 then determines whether or not, for example, all of X preset categories have been annotated (S33). In accordance with a determination that all have not been annotated (NO in S33), the metadata annotation unit 3 repeats the process from step S32. On the other hand, in accordance with a determination that all have been annotated (YES in S33), the metadata annotation unit 3 stores the annotated metadata group (metadata tree) in the metadata storage unit 14 (S34).

Here, an example of the metadata group stored in the metadata storage unit 14 is shown in FIG. 12A.

“Identification information” (Cluster1, Cluster2, Cluster11, Cluster12, . . . ) of the respective clusters and “metadata annotation categories” corresponding to the respective clusters are recorded for each “metadata tree” in the metadata storage unit 14. The “metadata annotation category” includes statistical values such as a maximum value, a minimum value, and an average, a relative concept (corresponding to “relative semantics”), and the like. Information in each row is a synopsis (synopsis₁, synopsis₂, . . . ) to be described below.

Operation at Time of Metadata Search

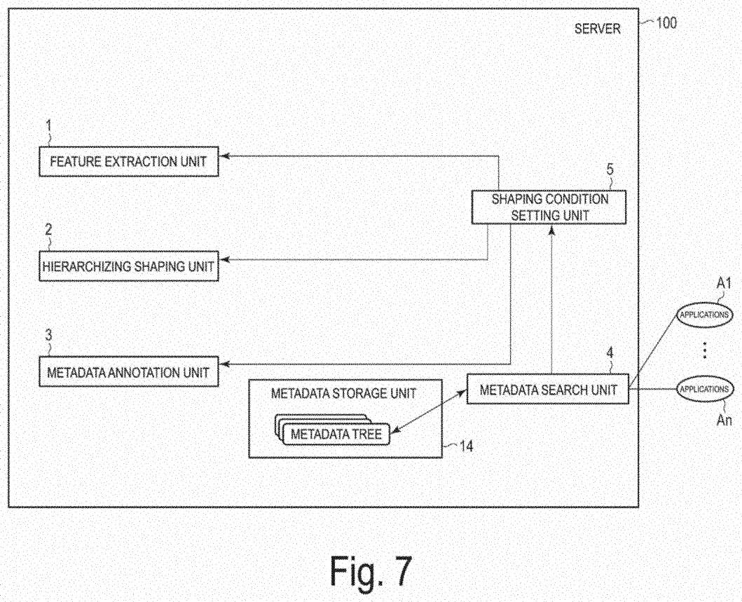

Next, an example of an operation at the time of a metadata search will be described with reference to FIGS. 7 to 11.

FIG. 7 shows various elements relevant to the operation of the metadata search or the like.

As shown in FIG. 7, the various elements relevant to the operation at the time of a metadata search are the group of applications A1 to An, the metadata search unit 4, and the metadata storage unit 14. When a setting of the shaping condition is required, the shaping condition setting unit 5, the feature extraction unit 1, the hierarchical shaping unit 2, and the metadata annotation unit 3 are also relevant to the operation.

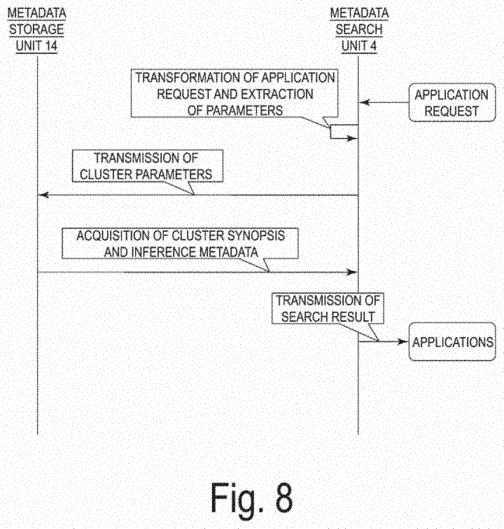

FIG. 8 shows an example of a flow of information exchanged between various elements relevant to the operation at the time of a metadata search (here, when a metadata tree that is a search target is present in the metadata storage unit 14).

As shown in FIG. 8, a request is transmitted from any application in the group of applications A1 to An to the metadata search unit 4.

The metadata search unit 4 performs a predetermined transformation process on a received request, and extracts parameters.

The metadata search unit 4 then transmits the extracted parameters (cluster parameters) to the metadata storage unit 14.

This causes the metadata storage unit 14 to read metadata of a synopsis (with an inferred annotation) of the cluster group corresponding to those cluster parameters.

The metadata search unit 4 acquires the read metadata of the synopsis (with an inferred annotation) of the cluster group and transmits the metadata to the application that is a request source.

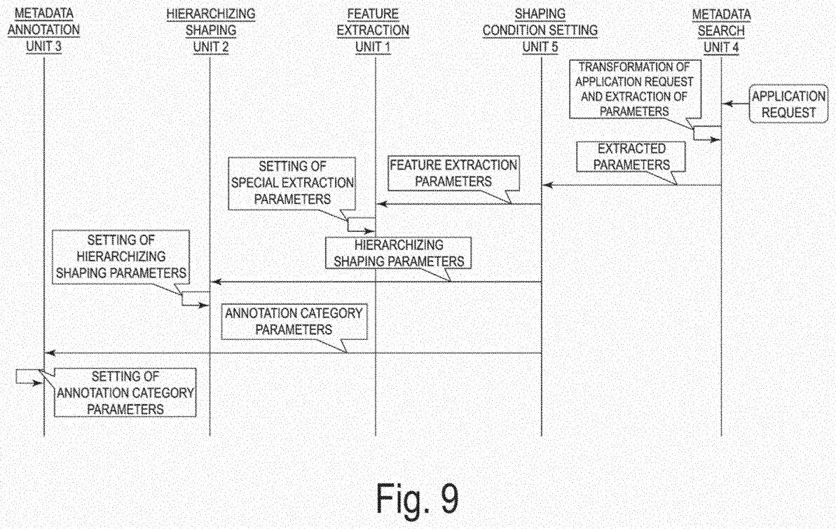

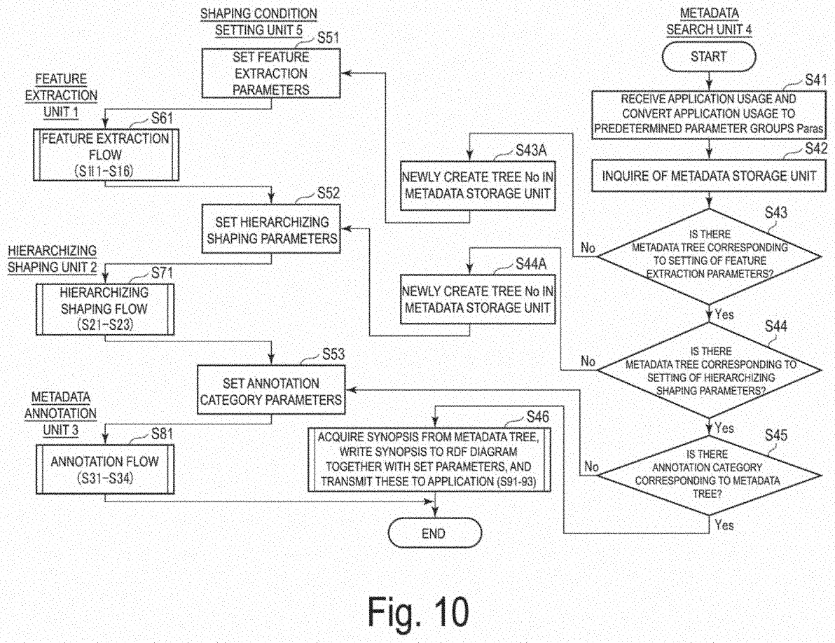

FIG. 9 shows an example of a flow of information exchanged between various elements relevant to the operation at the time of a metadata search (here, when a metadata tree that is a search target is not present in the metadata storage unit 14).

As shown in FIG. 9, a request is transmitted from any application in the group of applications A1 to An to the metadata search unit 4.

The metadata search unit 4 performs a predetermined transformation process on a received request, and extracts parameters.

Next, even when the metadata search unit 4 transmits the extracted parameters to the metadata storage unit 14, the metadata search unit 4 transmits a request for a setting of the parameters to the shaping condition setting unit 5 in a case in which the metadata of the synopsis (with an inferred annotation) of the cluster group corresponding to the parameters is not read. Here, the parameters are the feature extraction parameters, the hierarchical shaping parameters, or the annotation category parameters described above.

When a request for a setting of the feature extraction parameters has been received, the shaping condition setting unit 5 transmits the feature extraction parameters to the feature extraction unit 1.

When the feature extraction parameters have been received, the feature extraction unit 1 performs a setting of the feature extraction parameters.

When a request for a setting of the hierarchical shaping parameter has been received, the shaping condition setting unit 5 transmits the hierarchical shaping parameters to the hierarchical shaping unit 2.

When the hierarchical shaping parameters have been received, the hierarchical shaping unit 2 performs a setting of the hierarchical shaping parameters.

Further, when a request for a setting of the annotation category parameters has been received, the shaping condition setting unit 5 transmits the annotation category parameters to the metadata annotation unit 3.

When the metadata annotation parameters have been received, the metadata annotation unit 3 performs the setting of the metadata annotation parameters.

FIG. 10 is a flowchart showing an example of an operation at the time of a metadata search in the metadata search unit 4 and the like.

As shown in FIG. 10, when the metadata search unit 4 receives a usage from any application, the metadata search unit 4 performs a transformation to a predetermined parameter group Paras (S41). This allows the feature extraction parameters, the hierarchical shaping parameters, and the metadata annotation parameters to be obtained.

The metadata search unit 4 then inquires of the metadata storage unit 14 whether there are respective metadata trees corresponding to the feature extraction parameters, the hierarchical shaping parameters, and the metadata annotation parameters (S42).

When the metadata search unit 4 obtains a response indicating that there is no metadata tree corresponding to the feature extraction parameters (NO in S43), the metadata search unit 4 requests the metadata storage unit 14 to create a storage unit and a tree number of a new corresponding tree (S43A), and requests the shaping condition setting unit 5 to set the feature extraction parameters. When the setting of the feature extraction parameters is requested by the metadata search unit 4, the shaping condition setting unit 5 instructs the feature extraction unit 1 to set the feature extraction parameters (S51).

Meanwhile, an operation when the metadata search unit 4 obtains a response indicating that there is no metadata tree corresponding to the hierarchical shaping parameters (NO in S44) even when the metadata search unit 4 obtains, in step S43, a response indicating that there is a metadata tree corresponding to the feature extraction parameters (YES in S43) will be described. In this case, the metadata search unit 4 requests the metadata storage unit 14 to newly create a storage unit and a tree number of a new corresponding tree (S44A) and requests the shaping condition setting unit 5 to set the hierarchical shaping parameters. When a setting of the hierarchical shaping parameters is requested by the metadata search unit 4, the shaping condition setting unit 5 instructs the hierarchical shaping unit 2 to set the hierarchical shaping parameter (S52).

Meanwhile, an operation when the metadata search unit 4 obtains a response indicating that there is no metadata tree corresponding to the metadata annotation parameters (NO in S45) even when the metadata search unit 4 obtains, in step S44, a response indicating that there is a metadata tree corresponding to the hierarchical shaping parameters (YES in S44) will be described. In this case, the metadata search unit 4 requests the shaping condition setting unit 5 to set the annotation category parameters. When a setting of the annotation category parameters is requested by the metadata search unit 4, the shaping condition setting unit 5 instructs the metadata annotation unit 3 to set the annotation category parameters (S53).

On the other hand, when the metadata search unit 4 obtains, in step S45, a response indicating that there is a metadata tree corresponding to the metadata annotation parameters (YES in S45), the operation at the time of the metadata search proceeds to step S46.

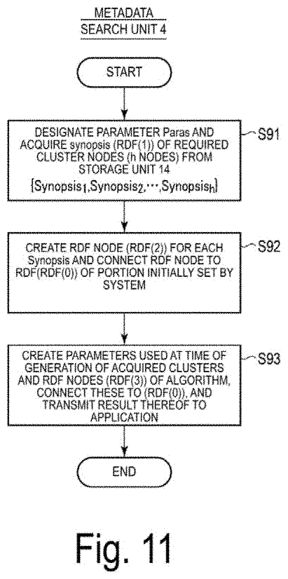

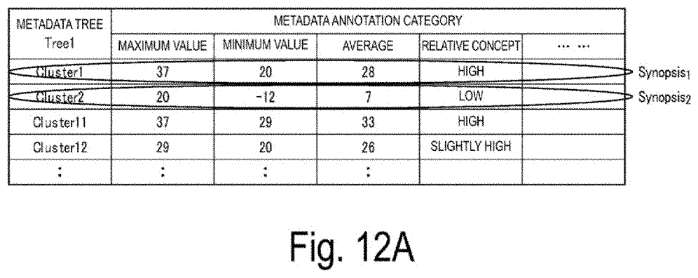

In step S46, the metadata search unit 4 acquires metadata including a synopsis of the clusters suitable for the usage indicated by the application that is a request source from the metadata tree. The metadata search unit 4 writes the acquired metadata together with information on the set parameters in a diagram in a Resource Description Framework (RDF) format and transmits these to the application that is a request source. Specifically, processes of steps S91 to S93 shown in FIG. 11 are performed and the series of processes ends.

When the feature extraction unit 1 is instructed to set the feature extraction parameters by the shaping condition setting unit 5, the feature extraction unit 1 performs the same processes as those of steps S1l to S16 described above (S61). After the process of step S61 has been performed, the shaping condition setting unit 5 instructs the hierarchical shaping unit 2 to set the hierarchical shaping parameter (S52).

When the hierarchical shaping unit 2 is instructed to set the hierarchical shaping parameter by the shaping condition setting unit 5, the same processes as those in steps S21 to S23 described above are performed (S71). After the process of step S71 has been performed, the shaping condition setting unit 5 instructs the metadata annotation unit 3 to set the annotation category parameters (S53).

When a setting of the annotation category parameters is instructed by the shaping condition setting unit 5, the metadata annotation unit 3 performs the same processes as those in steps S31 to S34 described above (S81), finally passes the annotation result to the application, and ends the series of processes.

Here, FIG. 12B shows an example of information recorded in the metadata storage unit 14 when a setting of various parameters (a setting of a shaping condition) has been performed through the metadata search unit 4 and the shaping condition setting unit 5.

A shaping record is stored in the metadata storage unit 14 each time a new tree is created. The shaping record includes information for identifying the tree (such as numbers of trees), feature extraction parameters (such as a span (TimeSpan) time interval (segment) and information on an algorithm (Algorithm)), and a hierarchizing parameter (such as information on an algorithm (Algorithm)).

Next, a specific process of step S46 in FIG. 10 will be described with reference to FIG. 11.

First, the metadata search unit 4 designates a parameter group Paras and acquires a synopsis (synopsis₁, synopsis₂, . . . , synopsisₕ) of (h) cluster nodes as shown in FIG. 12A from the metadata storage unit 14A (S91). Here, the synopsis is referred to as RDF(1).

The metadata search unit 4 then creates an RDF node for each synopsis (the synopsis is referred to as RDF(2)) and connects the RDF node to a RDF (the synopsis is referred to as RDF(0)) of a portion initially set by the system (S92).

The metadata search unit 4 then creates the acquired parameters used at the time of the generation of the cluster and the RDF node of the algorithm (the synopsis is referred to as RDF(3)) using, for example, a shaping record as shown in FIG. 12B, and connects these to RDF(0). Finally, the metadata search unit 4 transmits metadata in which RDF(0), RDF(1), RDF(2), and RDF(3) are connected, to the application that is a request source ((S93)).

Thus, when metadata corresponding to the setting of the parameters indicated by the usage of the application is not present in the metadata storage unit 14, the shaping condition setting unit 5 adjusts the parameters used in the process by the feature extraction unit 1, the hierarchical shaping unit 2, or the metadata annotation unit 3. Thus, the metadata search unit 4 can appropriately handle the usage indicated by the application.

### Example (1)

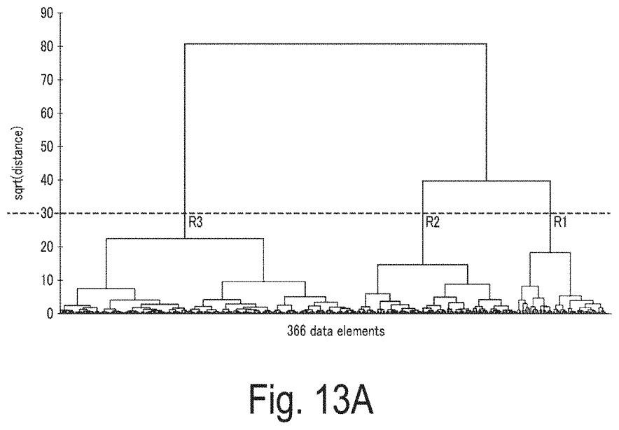

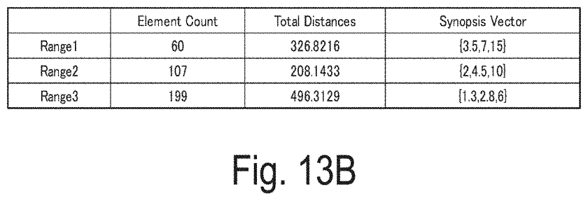

Next, Example (1) in the embodiment will be described with reference to FIGS. 13A to 17B. In this Example (1), “wind speed data” will be described by way of example.

Input of sensing data and generation of group of feature vectors Raw data is a time series of sensing data. In this example, an amount (approximately 15,800,000) for one year of wind speed sensing data acquired every second is handled.

Further, in this example, the feature extraction unit 1 combines the features of the same data “daily (maximum (Max) of the wind speed data in an east-west direction|maximum (Max2) of the wind speed in an south-north direction average (A)” to generate the group of feature vectors for clustering (366). This greatly reduces the amount of data.

Usage of Application

Usage of application 1: It is assumed that a wind speed situation is divided into three stages (in this case, for example, it is assumed that the cluster group needs to be divided into cluster1: “High”, cluster2: “Medium”, and cluster3: “Low”).

Usage of Application 2: It is assumed that the distance between the clusters is designated as a predetermined value (it is assumed that the distance between the clusters (Ward Distance) is for example “10”) (in this case, it is assumed that the cluster group needs to be divided into, for example, cluster1 to cluster6).

Clustering and impartment of metadata (corresponding to the usage of application 1) When the hierarchical shaping unit 2 performs the hierarchizing clustering on the group of feature vectors generated by the feature extraction unit 1, a result thereof is in a tree form that in FIG. 13A. In FIG. 13A, a horizontal axis represents a group of feature vectors (366 elements), and a vertical axis represents the distance between the clusters. For the usage of application 1, the tree is divided into three clusters (R1, R2, and R3), as indicated by a position of a dashed line in FIG. 13A.

In this case, the metadata annotation unit 3 imparts metadata as shown in FIG. 13B as information on each of the clusters. In FIG. 13B, Range1, Range2, and Range3 indicate three divided regions. For each of the regions, an element count, a total distance, and a synopsis vector are recorded. Using such information, an annotation may be created for each of the nodes of the cluster tree for each of the categories.

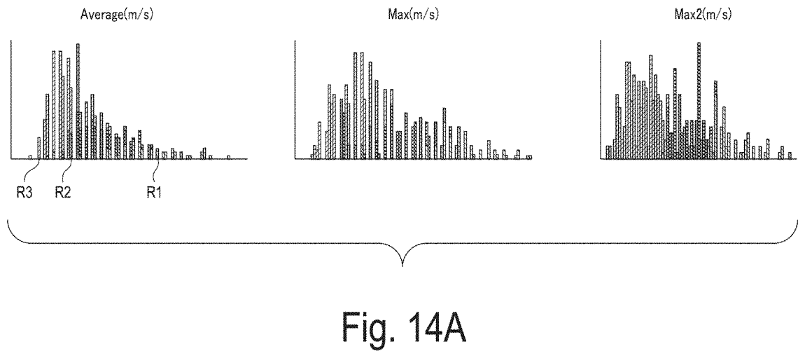

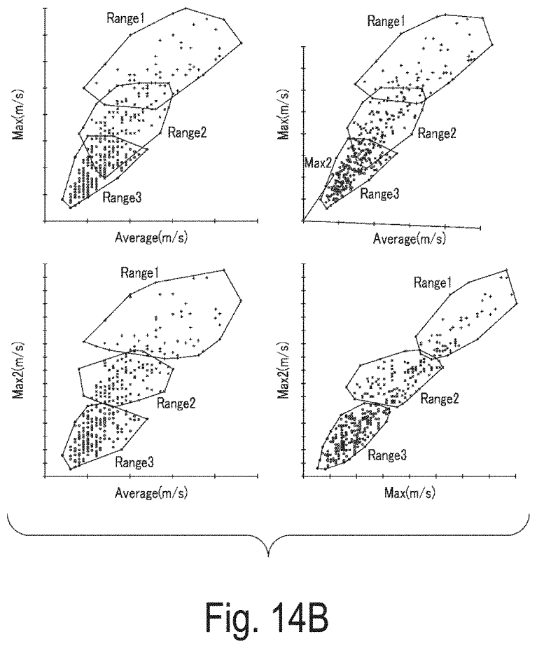

Distributions of cluster groups divided according to the usage of application 1 can be represented as in FIGS. 14A and 14B.

FIG. 14A shows respective histograms of Average, Max, and Max2. In FIG. 14A, a horizontal axis represents values of Average, Max, and Max2, and a vertical axis represents respective powers. R1, R2, and R3 correspond to cluster groups of Range1, Range2, and Range3, respectively.

FIG. 14B shows an example of graphs in which distributions of cluster groups of three divided regions Range1, Range2, and Range3 are represented on a three-dimensional coordinate system including 3 axes including Average, Max, and Max2. In FIG. 14B, four types of graphs are obtained by changing viewing directions.

On application 1 side, it is possible to reproduce graphs as shown in FIGS. 14A and 14B based on the received metadata.

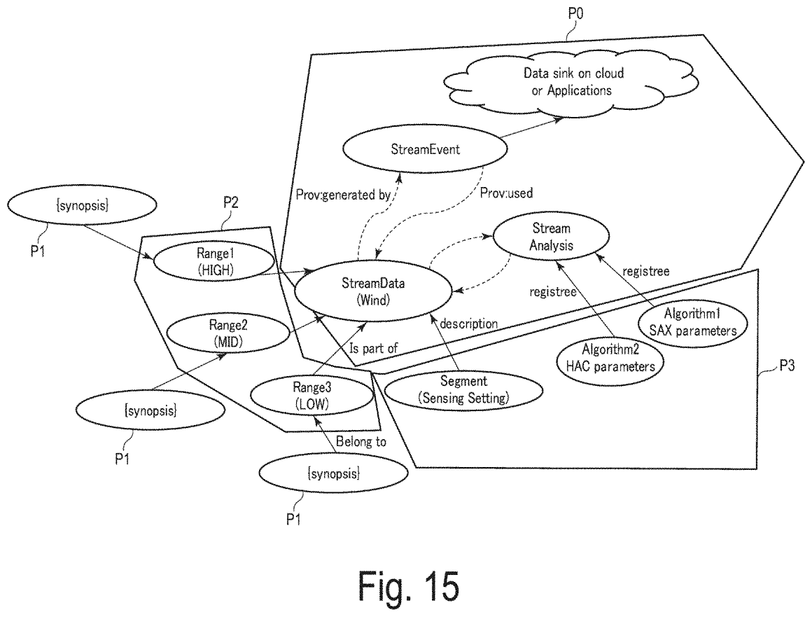

Configuration of metadata (corresponding to usage of application 1) Finally, the metadata search unit 4 transmits metadata in the form of RDF to application 1. The metadata search unit 4, for example, creates an ontology as shown in FIG. 15 and transmits the metadata to application 1. In FIG. 15, P0, P1, P2, and P3 correspond to RDF(0), RDF(1), RDF(2), and RDF(3) described above, respectively.

P0 is initially set by the system and stored in the metadata storage unit 14. P1 is acquired from the metadata storage unit 14 by the metadata search unit 4. P2 is created by the metadata annotation unit 3. P3 is set by the metadata search unit 4 and the shaping condition setting unit 5 and stored in the metadata storage unit 14.

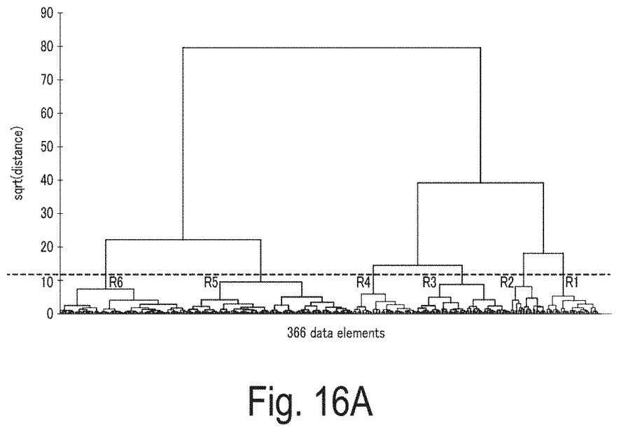

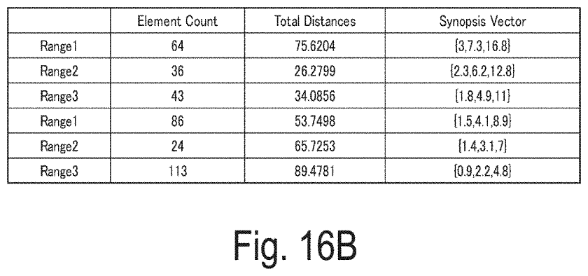

Clustering and impartment of metadata (corresponding to usage of application 2) The same clustering as in application 1 is also used for application 2, as in FIG. 16A. However, the tree is divided into six cluster groups (R1 to R6), as indicated by a position of a dashed line in FIG. 16A.

In this case, the metadata annotation unit 3 imparts metadata as shown in FIG. 16B as information on each of the clusters. In FIG. 16B, Range1 to Range6 indicate six divided regions. Recorded items are the same as in FIG. 13B.

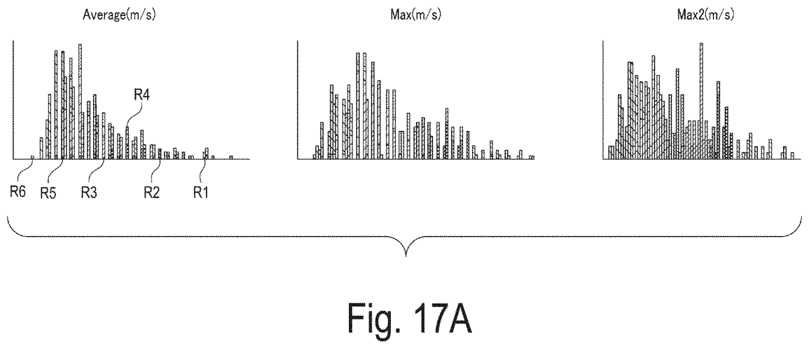

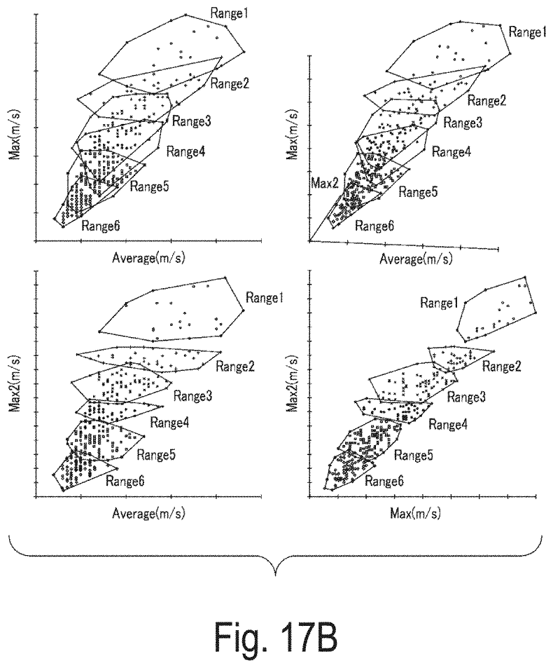

Distributions of cluster groups divided according to the usage of application 2 can be represented as those in FIGS. 17A and 17B.

FIG. 17A shows respective histograms of Average, Max, and Max2. R1 to R6 correspond to cluster groups of Range1 to Range6, respectively.

FIG. 17B shows an example of graphs in which distributions of cluster groups of six divided regions Range1 to Range6 are represented on a three-dimensional coordinate system including 3 axes including Average, Max, and Max2. In FIG. 17B, four types of graphs are obtained by changing viewing directions.

On application 2 side, it is possible to reproduce graphs as shown in FIGS. 17A and 17B based on the received metadata.

### Example 2

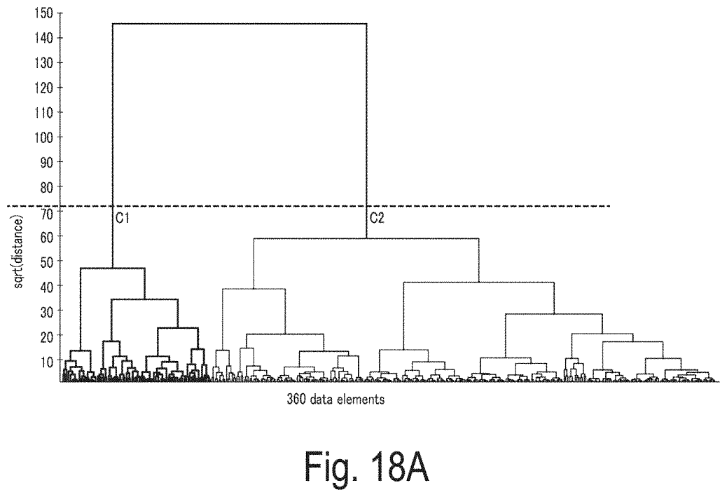

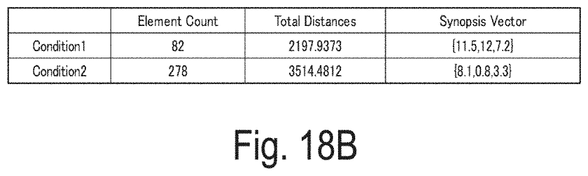

Next, Example (2) in the embodiment will be described with reference to FIGS. 18A to 22B. In this Example (2), an example in which “wind speed data”, “air temperature data”, and “sunlight time data” are mixed will be described.

Input of sensing data and generation of group of feature vectors Raw data is a time series of sensing data. In this example, an amount for a year of wind speed and air temperature sensing data acquired every second and an amount for one year of daily sunlight time data are handled.

In this example, the feature extraction unit 1 combines the features of the three types of different data “daily wind speed average, air temperature average, and sunlight time” to generate a group of feature vectors representing a daily weather situation for one year, unlike Example (1). This greatly reduces the amount of data.

Usage of Application

Usage of application 3: it is assumed that a weather situation is divided into two categories (in this case, it is assumed that the cluster group needs to be divided into, for example, cluster1 and cluster2).

Usage of application 4: It is assumed that two specific days (for example, May 1 and June 2) belong to one category (in this case, it is assumed that the cluster group needs to be divided into cluster1 to cluster12, for example).

Clustering and impartment of metadata (corresponding to usage of application 3) When the hierarchical shaping unit 2 performs the hierarchizing clustering on the group of feature vectors generated by the feature extraction unit 1, a result thereof is in a tree form as shown in FIG. 18A. In FIG. 18A, a horizontal axis represents a group of feature vectors (360 elements), and a vertical axis represents the distance between the clusters. For the usage of application 3, the tree is divided into two clusters (C1 and C2), as indicated by a position of a dashed line in FIG. 18A.

In this case, the metadata annotation unit 3 imparts metadata as shown in FIG. 18B as information on each of the clusters. In FIG. 18B, Condition1 and the Condition2 indicate two divided regions. For each of the regions, an element count, a total distance, and a synopsis vector are recorded. Using such information, an annotation may be created for each of the nodes of the cluster tree for each of the categories.

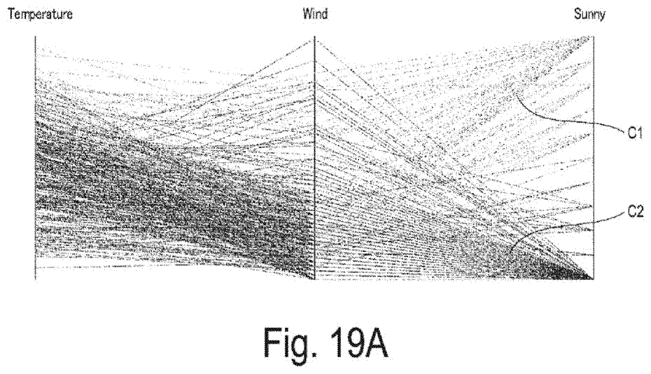

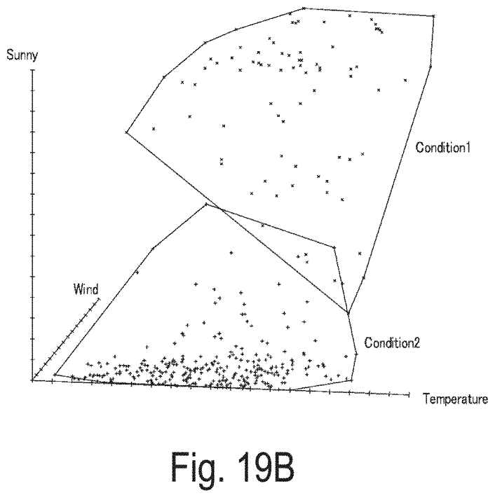

Distributions of cluster groups divided according to the usage of application 4 can be represented as in FIGS. 19A and 19B.

FIG. 19A is a correlation diagram of each of air temperature (Temperature), wind speed (Wind), and sunlight time (Sunny). In FIG. 19A, C1 and C2 correspond to cluster groups of Condition1 and Condition2, respectively.

FIG. 19B shows an example of a graph in which a distribution of cluster groups of two divided regions Condition1 and Condition2 is represented on a three-dimensional coordinate system including 3 axes including Temperature, Wind, and Sunny.

On application 3 side, it is possible to reproduce graphs as shown in FIGS. 19A and 19B based on the received metadata.

Configuration of Metadata (Corresponding to Usage of Application 1)

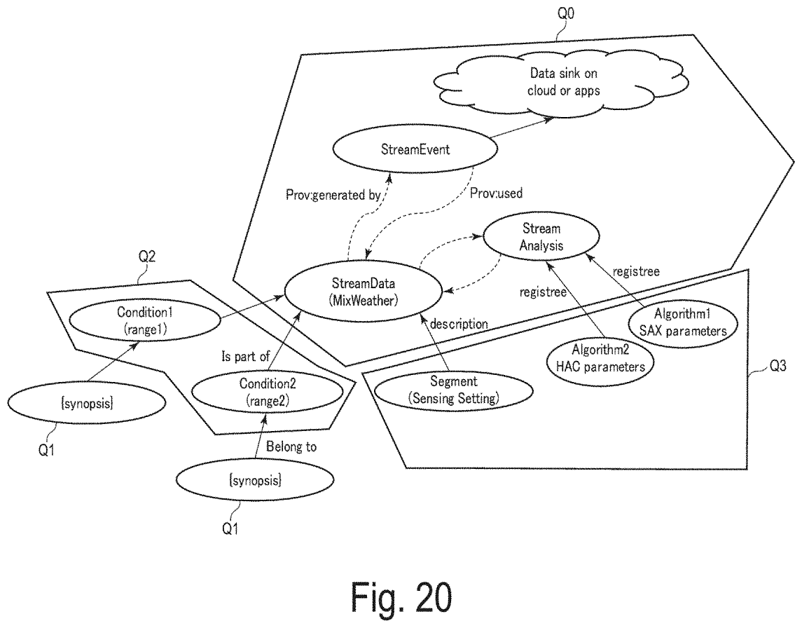

Finally, the metadata search unit 4 transmits metadata in the form of RDF to application 3. The metadata search unit 4, for example, creates an ontology as shown in FIG. 20 and transmits the metadata to application 3. In FIG. 20, Q0, Q1, Q2, and Q3 correspond to RDF(0), RDF(1), RDF(2), and RDF(3) described above, respectively.

Q0 is initially set by the system and stored in the metadata storage unit 14. Q1 is acquired from the metadata storage unit 14 by the metadata search unit 4. Q2 is created by the metadata annotation unit 3. Q3 is set by the metadata search unit 4 and the shaping condition setting unit 5 and stored in the metadata storage unit 14.

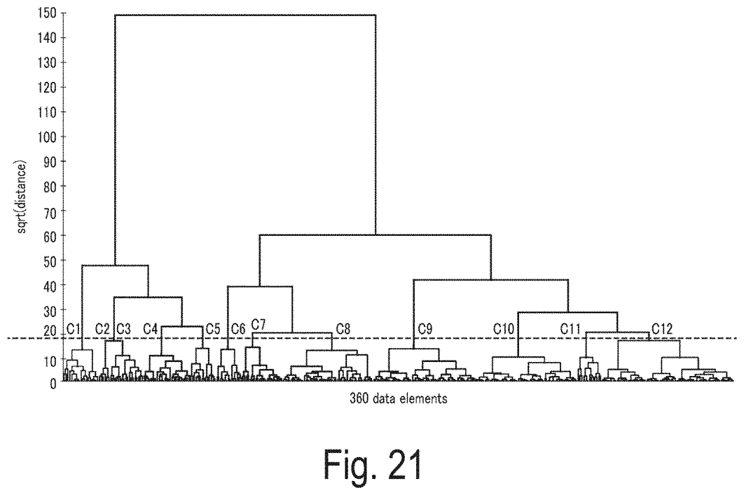

Clustering and impartment of metadata (corresponding to usage of application 4) The same clustering as in application 3 is also used for application 4, as in FIG. 21. However, the tree is divided into 12 cluster groups (C1 to C12), as indicated by a position of a dashed line in FIG. 21.

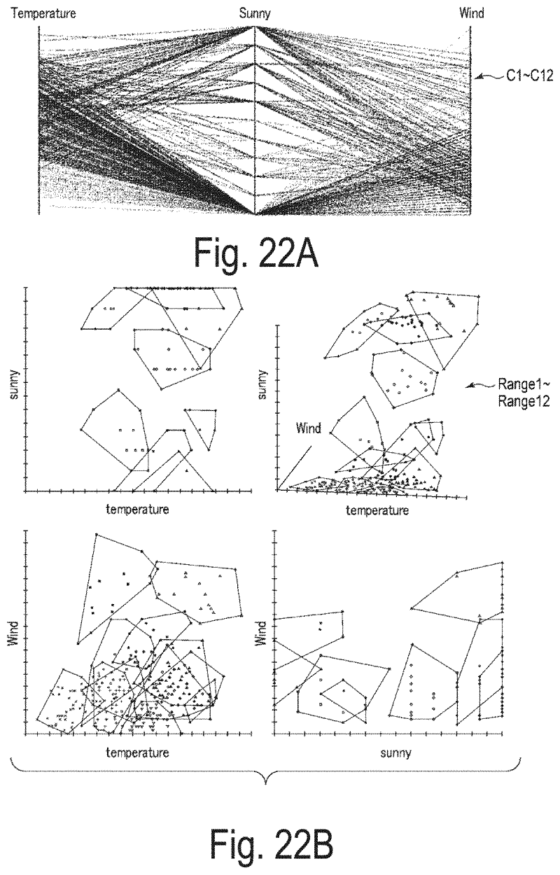

Distributions of cluster groups divided according to the usage of application 3 can be represented as in FIGS. 22A and 22B.

FIG. 22A is a correlation diagram of each of air temperature (Temperature), wind speed (Wind), and sunlight time (Sunny). In FIG. 22A, C1 to C12 correspond to cluster groups of Condition1 and Condition12, respectively.

FIG. 22B shows an example of graphs in which distributions of cluster groups of 12 divided regions Condition1 to Condition12 are represented on a three-dimensional coordinate system including 3 axes including Temperature, Wind, and Sunny.

On application 4 side, it is possible to reproduce graphs as shown in FIGS. 22A and 22B based on the received metadata.

According to the first embodiment, through hierarchized data shaping executed on the server side, it is possible to provide information required by the application without performing calculation each time in response to requests of various applications that utilize IoT data. Therefore, because it is not necessary for the application side to receive and process all pieces of IoT data, reduction in a process can be expected. Further, because only the data required by the application is provided from the server to the application, it is possible to greatly curb communication costs or an amount of traffic. This makes it possible to efficiently and inexpensively provide data even in an environment in which applications or a large number of devices using IoT data will be present in the future.

### Second Embodiment

Next, a second embodiment of the present invention will be described. Hereinafter, description of parts that are the same as those in the first embodiment will be omitted, and different parts will be mainly described.

Configuration

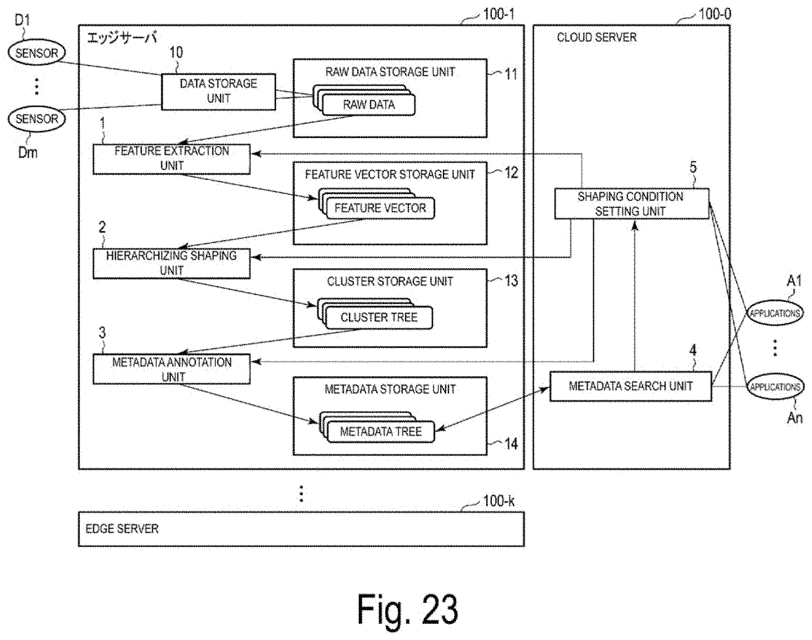

FIG. 23 is a diagram illustrating an example of a functional configuration of an information exchange system according to a second embodiment of the present invention. In FIG. 23, elements that are the same as those in FIG. 1 are denoted by the same reference signs.

The information exchange system according to the second embodiment is a combination of a cloud server 100-0 on a cloud and one edge server 100-1 or a plurality of edge servers 100-1, . . . , 100k. The cloud server provides services in response to requests from applications installed in other information processing apparatuses (not shown), for example. The edge server is installed at each of places at which a sensing data group supplied from a group of devices such as the sensors D1 to Dm and the like can be acquired. The cloud server 100-0 and the edge server 100-1, . . . , 100k are communicatively connected to each other and are able to exchange information with each other.

As shown in FIG. 23, the feature extraction unit 1, the hierarchical shaping unit 2, and the metadata annotation unit 3 are respectively disposed on the edge server 100-1, . . . , 100k side. On the other hand, the metadata search unit 4 and the shaping condition setting unit 5 are installed on the cloud server 100-0 side. The functions and operations of the feature extraction unit 1, the hierarchical shaping unit 2, the metadata annotation unit 3, the metadata search unit 4, and the shaping condition setting unit 5 are the same as those in the first embodiment.

According to the second embodiment, the feature extraction unit 1, the hierarchical shaping unit 2, and the metadata annotation unit 3 are disposed on the edge server 100-1, . . . , 100k side rather than being disposed on the cloud server 100-0 side on the cloud. Thus, the cloud server 100-0 need not receive a large amount of raw data and may perform communication to the extent to which the metadata is exchanged. Therefore, a burden on the cloud server 100-0 side is significantly reduced, thereby contributing to reduction in a load of a cloud layer and reducing an amount of traffic (cost) between edges and cloud.

As described in greater detail above, according to each of the embodiments of the present invention, it is possible to efficiently generate data required by the applications.

### INDUSTRIAL APPLICABILITY

The present invention is not limited to the embodiments, and various modifications can be made without departing from the gist of the present invention in an implementing stage. Further, the embodiments may be implemented in appropriate combination, and in this case, effects of the combination can be obtained. Further, various inventions are included in the above embodiments and can be extracted by a combination selected from a plurality of configuration requirements that are disclosed. For example, in a case in which problems can be solved and effects can be obtained even when some configuration requirements are removed from all of configuration requirements shown in the embodiments, a configuration in which the configuration requirements have been removed can be extracted as an invention.

Further, a scheme described in each of the embodiments is stored in a recording medium such as a magnetic disk (a Floppy (registered trademark) disk, a hard disk, or the like), an optical disc (a CD-ROM, a DVD, an MO, or the like), a semiconductor memory (a ROM, a RAM, a flash memory, or the like) or transferred by a communication medium for distribution, as a program (a software unit) that can be executed by a calculator (a computer). The program stored in the medium also includes a setting program for causing a software unit (including not only an execution program but also a table or data structure), which will be executed in a calculator, to be configured within the calculator. A calculator realizing the present apparatus executes the above-described process by loading the program recorded on the recording medium or constructing a software unit using the setting program in some cases, and controlling an operation using the software unit. The recording medium referred to herein is not limited to a recording medium for distribution, and includes a storage medium such as a magnetic disk or a semiconductor memory provided inside the calculator or in a device connected via a network.

### REFERENCE SIGNS LIST

1: Feature extraction unit
2: Hierarchizing shaping unit
3: Metadata annotation unit
4: Metadata search unit
5: Shaping condition setting unit
10: Data storage unit
11: Raw data storage unit
12: Feature vector storage unit
13: Cluster storage unit
14: Metadata storage unit
100: Server
100-0: Cloud server
100-1 to 100-k: Edge server
A1 to An: Group of application
D1 to Dm: Sensor

1. An information processing apparatus comprising:
a processor; and
a storage medium having computer program instructions stored thereon, when executed by the processor, perform to:
extract a plurality of features from a data group supplied from a device and generate a group of feature vectors obtained by representing the plurality of features with vectors;
perform clustering according to a distance between feature vectors on the group of feature vectors generated by the feature extraction unit to generate a cluster tree obtained by hierarchizing cluster groups generated by the clustering according to a distance between the clusters;
generate a metadata tree, the metadata tree including, for each of the clusters, metadata obtained by annotating a synopsis obtained by summarizing information under each of the clusters, based on the cluster tree generated by the hierarchical shaping unit; and
search the metadata tree generated by the metadata annotation unit for metadata of a cluster suitable for a usage indicated by an application and provide the metadata obtained through the search to the application.

2. The information processing apparatus according to claim 1, wherein, when the application indicates a granularity of a data group as the usage, and the computer program instruction further perform to read a metadata of a cluster located in a layer corresponding to the granularity from the metadata tree.

3. The information processing apparatus according to claim 1, wherein when the application designates a range of physical amounts of a data group toward the bottom as the usage, and the computer program instruction further perform to traverses the metadata tree from a top layer toward a bottom layer and sequentially narrows down the range of the physical amounts recorded in the metadata of each of the clusters, to thereby find and read metadata in which the corresponding range is recorded.

4. The information processing apparatus according to claim 1, wherein the computer program instruction further perform to adjust parameters used in a process by the feature extraction unit, the hierarchical shaping unit, or the metadata annotation unit according to the usage indicated by the application.

5. An information exchange system for exchanging information between one or a plurality of first information processing apparatuses storing a data group supplied from a device and a second information processing apparatus responding to a request from an application,
wherein each of the one or plurality of first information processing apparatuses includes
a processor; and
a storage medium having computer program instructions stored thereon, when executed by the processor, perform to:
extract a plurality of features from the data group supplied from the device and generate a group of feature vectors obtained by representing the plurality of features with vectors;
perform clustering according to a distance between feature vectors on the group of feature vectors to generate a cluster tree obtained by hierarchizing cluster groups generated by the clustering according to a distance between the clusters; and
generate a metadata tree, the metadata tree including, for each of the clusters, metadata obtained by annotating a synopsis obtained by summarizing information under each of the clusters, based on the cluster tree, and
the second information processing configured to request any one of the one or plurality of first information processing apparatuses to search the metadata tree for metadata of a cluster suitable for a usage indicated by the application, and provide the metadata obtained through the search to the application.

6. An information processing method comprising:
extracting a plurality of features from a data group supplied from a device and generating a group of feature vectors obtained by representing the plurality of features with vectors;
classifying the generated group of feature vectors into a plurality of clusters according to a distance between feature vectors and generating a cluster tree obtained by hierarchizing the plurality of clusters according to a distance between the clusters;
generating a metadata tree, the metadata tree including, for each of the clusters, metadata obtained by annotating a synopsis obtained by summarizing information under each of the clusters, based on the generated cluster tree; and
searching the generated metadata tree for metadata of a cluster suitable for a usage indicated by an application and providing the metadata obtained through the search to the application.

7. A non-transitory computer-readable medium having compute-executable instructions that, upon execution of the instructions by a processor of a computer, cause the computer to function as the information processing apparatus according to claim 1.
